(19) United States
(12) Patent Application Publication
(10) Pub. No.: US 2009/0117419 A1
(43) Pub. Date: May 7, 2009

(54) DRY-STATE DETECTING METHOD AND ELECTRONIC DEVICE SYSTEM FOR FUEL CELL, AND POWER CONTROL METHOD THEREFOR

(75) Inventors: Tsuyoshi Takemoto, Tokyo (JP); Takahisa Kitaguchi, Tokyo (JP); Yoshitaka Tokita, Tokyo (JP); Toshimichi Kawai, Tokyo (JP); Toshiaki Nakazawa, Tokyo (JP); Takeshi Obata, Tokyo (JP); Hiroshi Kajitani, Tokyo (JP); Takashi Manako, Tokyo (JP); Hidekazu Kimura, Tokyo (JP); Shin Nakamura, Tokyo (JP)

Correspondence Address: YOUNG & THOMPSON, 209 Madison Street, Suite 500, ALEXANDRIA, VA, 22314, US

(73) Assignees: NEC Corporation, Minato-ku Tokyo (JP); NEC Personal Products, Shinagawa-ku Tokyo (JP)

(21) Appl. No.: 12/092,833

(22) PCT Filed: Oct. 25, 2006
(86) PCT No.: PCT/JP2006/321201

§ 371 Date: May 7, 2008

(30) Foreign Application Priority Data
Nov. 7, 2005 (JP) 2005 322245

(51) Int. Cl. H01M 8/00

(52) U.S. Cl. 429/13

(57) ABSTRACT

Provided are a dry-state detecting method and an electronic device system for a fuel cell, which detect the dry state of an electrolyte film precisely, and a power control method for optimizing the control of a starting time on the basis of the dry state detected. The fuel cell is constituted to include an electrolyte film, and a catalyst electrode and a gas diffusion electrode disposed on the two faces of the electrolyte film. The dry-state detecting method detects the dry state on the basis of a displacement of the electrolyte film in an in-plane direction.

### TECHNICAL FIELD

The present invention relates to an electronic device and an electronic device system powered by a fuel cell, and a power control method therefor, and, in particular, relates to a dry-state detection method for a fuel cell when controlling the fuel cell by detecting a dry state thereof, and an electronic device system and a power control method therefor.

### BACKGROUND ART

Recently, portable information processing apparatuses such as note-type personal computers, PDAs (Personal Digital Assistants), and the like are in wide spread use. As the power source for such portable electronic devices, primarily, secondary batteries such as a lithium ion battery are being used. Further, due to higher power consumption that seems from improved performance of such information processing apparatuses and the demand for longer run times, expectation is placed on fuel cells as a new power source which can provide high power and which does not require charging.

A fuel cell generates power through the reaction of hydrogen and oxygen within a power generation part made up of an electrode assembly which is an integrated structure of an electrolyte film and an electrode (including a catalyst). The power generation part is generally called a MEA (Membrane Electrode Assembly) and may also herein be referred to as a “MEA”.

There are various forms of fuel cells, depending on the type of fuels and the method of supplying hydrogen to the power generation part, including direct methanol fuel cells (DMFCs), polymer electrolyte fuel cells (PEFCs), and reforming type fuel cells which utilize a reformer to extract hydrogen from a fuel such as methanol. The direct methanol types have gained attention as a power source for portable information processing apparatuses, because they provide ease of fuel handling and simplicity of system when compared with fuel cells fueled by hydrogen.

FIGS. 1(a) and 1(b) are a perspective view and a sectional view to show the structure of a direct methanol type MEA.

The MEA is made up of electrolyte film 31, catalytic electrodes 32 and 34 oppositely disposed and sandwiching electrolyte film 31, and gas diffusion electrodes 33 and 35 oppositely disposed and further sandwiching catalytic electrodes 32 and 34.

Regarding of catalytic electrodes 32 and 34, one operates as an anode and the other operates as a cathode. From now on, description will be made assuming that catalytic electrode 32 is the anode-side catalytic electrode and catalytic electrode 34 is the cathode-side catalytic electrode.

An alloy of Pt and Ru is typically used for the anode-side catalytic electrode and Pt is typically used for the cathode-side catalytic electrode. Conductive porous materials are used as gas diffusion electrode 33, 35 and for example carbon and SUS are used as the conductive material.

Viewed as focusing on electrolyte film 31, the surface on the side of catalytic electrode 32 and gas diffusion electrode 33 comes into contact with methanol and water, which provide the fuel, and an atmospheric condition is maintained on the surface on the side of catalytic electrode 34 and gas diffusion electrode 35.

When a fuel cell, which utilizes a MEA of the above described structure, is not used for a long period of time, its fuel will be released into the atmosphere through an electrolyte film, and eventually a part of or the entire MEA will be dried up. Such drying of MEA will lead to degradation or malfunction, and forcible activation thereof in such condition will result in a destruction or failure of the fuel cell.

When a part of or the entire MEA is dried up so that there is no water within electrolyte film 31, protons (hydrogen ions) cannot move within electrolyte film 31. Similarly, when water within the electrolyte binder included in catalytic electrodes 32 and 34 is depleted, protons generated at catalytic electrode 32 which acts as the anode cannot move to electrolyte film 31, and also can not move from electrolyte film 31 to catalytic electrode 34 which acts as the cathode.

In a situation in which MEA is dried as described above, normal power generation reaction will not take place since protons become unable to move in an unhumidified portion.

Although starting fuel supply of fuel to a MEA, which is in a dry state, will enable power generation of power, fuel will only partially penetrate the MEA within a short period of time after the supply of fuel has commenced, and some portions of the MAE will continue to be in a dry state because of the generally complicated, porous structure of catalytic electrode 32, 34. If the fuel cell in such a state has an electrically load on it, normal power generation will takes place only in the humidified part of catalytic electrode 32, 34. Thus, the load due to power generation is concentrated in the humidified part thereby accelerating degradation of the catalyst and electrolyte, and an abnormal electrochemical reaction occurs at the catalytic electrode and the gas diffusion electrode which are in a dry state resulting in a decline in the performance of the catalytic electrode and the gas diffusion electrode. Therefore, the fuel cell will not achieve a predetermined performance and there is a risk that a device powered by the fuel cell may malfunction.

In the case of a polymer electrolyte type in which hydrogen is supplied to the MEA, humidified hydrogen gas is fed to the catalytic electrode on the anode side, and water is concurrently supplied when the MEA comes into a dry state; however, as a matter of course, malfunctions due to drying, as observed in the above described direct methanol fuel cell, may similarly take place.

Related arts which have sought to address the problem of malfunction due to drying include a technique disclosed in Patent document 1 (Japanese Patent Laid-Open No. 2001-332280).

Patent document 1 discloses detecting a dry state of a stack, in which fuel cells are fixed in an expansible/contractible manner in the laminating direction and power is generated by using humidified hydrogen gas and air, based on the amount of displacement in the height (laminating direction) of the stack and the temperature thereof; and humidifying the stack by use of a humidifier when it is in a dry state.

Patent document 1: Japanese Patent Laid-Open No, 2001-332280

The technique disclosed by Patent document 1 determines a dry state based on an amount of displacement in the laminating direction of a stack, that is, the laminating direction of catalytic electrode 32, electrolyte film 31, and gas diffusion electrode 33 in the case of the example shown in FIG. 1.

However, variation of film thickness due to the dry state of electrolyte film 31 is infinitesimal, therefore a problem will arise in that it is difficult to accurately detect a dry state.

The present application has been made in view of the above described problem of related arts, and its object is to realize a dry-state detection method for a fuel cell, which enables accurate detection of a dry state of the electrolyte film, an electronic device system, and a power control method for optimizing control during activation based on the detected dry state.

### DISCLOSURE OF THE INVENTION

The dry-state detecting method for a fuel cell according to the present invention is a dry-state detecting method for a fuel cell comprising a power generation part, the power generation part being made up of an electrolyte film, and a catalytic electrode and a gas diffusion electrode which are disposed on each side of the electrolyte film, the dry-state detecting method characterized in that

a dry state is detected based on the amount of displacement in an in-plane direction of said electrolyte film.

The above-described configuration may be such that the frame electrode and the electrolyte film are integrally joined by a screw so that a dry state is detected based on the amount of strain in the frame electrode sandwiching the power generation part.

The configuration may also be such that the frame electrode and the electrolyte film are integrally joined by a screw so that a dry state is detected based on the position of a maker placed on the electrolyte film.

The configuration may also be such that the frame electrode and the electrolyte film are integrally joined by a screw so that a dry state is detected based on the amount of strain between the frame electrode sandwiching the power generation part and the power generation part.

The electronic device system of the present invention is an electronic device system comprising an information processing apparatus, and a fuel cell unit and a secondary battery unit for providing the supply of power to the information processing apparatus, characterized in that

the information processing apparatus comprises:

a first control part; and

a ratio-change/disconnect switch for changing the ratio of and disconnecting the power supply from the fuel cell unit and the secondary battery unit,

said fuel cell unit comprising:

a power generation part;

a humidity sensor for detecting the degree of dryness of the power generation part;

a storage part; and

a second control part which determines a dryness value indicating the degree of dryness detected by the humidity sensor to compare the dryness value with a reference dryness value pre-stored in the storage part, and which judges that the power generation part is in a dry state when the degree of dryness detected by the humidity sensor indicates a lower humidity than that indicated by the degree of dryness indicated by the reference dryness value, to notify the first control part of a dryness signal, and that

upon receiving the notification of a dryness signal, the first control part controls the ratio-change/disconnect switch such that power is supplied only from the secondary battery unit, or more power is supplied from the secondary battery unit.

The above-described configuration may be such that the fuel cell unit comprises

a tank for storing fuel to be supplied to the power generation part, and

the second control part performs control to cause fuel to be supplied from the tank to the power generation part when notifying the first control part of the dryness signal.

Further, the configuration may be such that the fuel cell unit comprises:

first and second tanks for storing fuel to be supplied to the power generation part; and

first and second fuel supply control means provided in a supply path respectively between the first and second tanks and the power generation part, and that

when notifying the first control part of a dryness signal, the second control part controls the first and second fuel supply control means such that fuel is supplied to the power generation part from either the first or second tank or more fuel is supplied to the power generation part from either the first or the second tank.

Further, the configuration may be such that when notifying the first control part of a dryness signal, the second control part controls the first and second fuel supply control means so as to supply less fuel than that during a normal operation.

Further, the configuration may be such that:

the power generation part is made up of an electrolyte film, and a catalytic electrode and a gas diffusion electrode which are provided on each side of the electrolyte film;

a frame electrode for sandwiching the power generation part is provided, and the frame electrode and the electrolyte film are integrally joined by a screw; and

the humidity sensor is adapted to detect the amount of strain in the frame electrode.

Further, the configuration may be such that:

the power generation part is made up of an electrolyte film provided with a marker, and a catalytic electrode and a gas diffusion electrode which are provided on each side of the electrolyte film;

a frame electrode for sandwiching the power generation part is provided, and the frame electrode and the electrolyte film are integrally joined by a screw; and

the humidity sensor is adapted to detect the position of the marker.

Further, the configuration may be such that:

the power generation part is made up of an electrolyte film, and a catalytic electrode and a gas diffusion electrode which are provided on each side of the electrolyte film;

a frame electrode for sandwiching the power generation part is provided, and the frame electrode and the electrolyte film are integrally joined by a screw; and

the humidity sensor is adapted to detect sheer stress between the frame electrode and the power generation part.

Further, the configuration may be such that:

the power generation part is made up of an electrolyte film provided with a marker, and a catalytic electrode and a gas diffusion electrode which are provided on each side of the electrolyte film;

a frame electrode for sandwiching the power generation part is provided, and the frame electrode and the electrolyte film are integrally joined by a screw; and

the humidity sensor is adapted to detect at least one from among the amount of strain in the frame electrode, a position of the marker, and sheer stress between the frame electrode and the power generation part.

The configuration may also be such that:

the electronic device system comprises a clock provided in the fuel cell unit as a humidity sensor;

when the information processing apparatus is activated or deactivated, the first control part notifies the second control part as such; and

the second control part acquires a time at which a notification of activation or deactivation of the information processing apparatus is received from the first control part, by referring to the clock, to store the time in the storage part, and in the case of a notification of activation, further calculates an activation time which is the time period from the time of previous activation or previous deactivation, to compare the activation time with a reference activation time pre-stored in the storage part, wherein the second control part is adapted to make a judgment that the power generation part is in a dry state if the determined activation time is longer than the reference activation time.

The power generation part of a fuel cell of the present invention is a power generation part of a fuel cell comprising an electrolyte film, and a catalytic electrode and a gas diffusion electrode which are disposed on each side of the electrolyte film, characterized in that

the frame electrode and the electrolyte film are integrally joined by a screw.

The power control method for an electronic device system according to the present invention is a power control method for an electronic device system comprising: a fuel cell unit including a power generation part, a humidity sensor for detecting the degree of dryness of the power generation part, a storage part, a first and a second tank, a first and a second valve provided in each supply path between each of the first and second tanks and the power generation part, and a second control part; a secondary battery unit; and an information processing apparatus including a ratio-change/disconnect switch which receives the supply of power from the fuel cell unit and the secondary battery unit, and which changes the ratio of and disconnects power supply from the first control part, the fuel cell unit and secondary battery unit, characterized in that the power control method comprises:

arranging that the secondary control part determines a dryness value that indicates the degree of dryness detected by the humidity sensor to compare the dryness value with a reference dryness value pre-stored in the storage part; and makes a judgment that the power generation part is in a dry state when the degree of dryness detected by the humidity sensor indicates lower humidity than that indicated by the reference dryness value, and notifies the first control part of the dryness signal;

controlling an open/close state of the first and second valves such that power is supplied to the power generation part only from either the first or second tank, or more power is supplied from either the first or second tank; and

arranging that upon receiving the notification of a dryness signal, the first control part performs control through the ratio-change/disconnect switch such that power is supplied only from the secondary battery unit, or more power is supplied from the secondary battery unit.

The above-described configuration may be such that after notifying the first control part of a dryness signal, the second control part controls the open/close state of the first and second valves so that the opening less than that during normal operation.

Further, the configuration may be such that the power control method further comprises:

providing a clock provided in the fuel cell unit;

arranging that when the information processing apparatus is activated or deactivated, the first control part notifies the second control part as such; and

arranging that the second control part acquires a time at which a notification of activation or deactivation of the information processing apparatus is received from the first control part by referring to the clock, to store the time in the storage part, and in the case of a notification of activation, further calculates an activation time which is the time period from the time of previous activation or previous deactivation to compare the activation time with a reference activation time pre-stored in the storage part, wherein the second control part is adapted to make a judgment that the power generation part is in a dry state if the determined activation time is longer than the reference activation time.

According to the present invention, since the amount of displacement in an electrolyte film in a dry state is detected in an in-plane direction of the film in which the amount of displacement is larger than in a thickness direction, a dry state can be detected with more accuracy thereby making it possible to effectively perform subsequent control using the dry state.

### BRIEF DESCRIPTION OF THE DRAWINGS

FIG. 1(a) is a perspective view and a sectional view to show the structure of a MEA for a direct methanol fuel cell;

FIG. 1(b) is a perspective view and a sectional view to show the structure of a MEA for a direct methanol fuel cell;

FIG. 2 is a block diagram to show the configuration of an exemplary embodiment of the present invention;

FIG. 3(a) is a top view to show the structure of MEA 205; and

FIG. 3(b) is a sectional view along line X-X′ in FIG. 3(a) to show the structure of MEA 205.

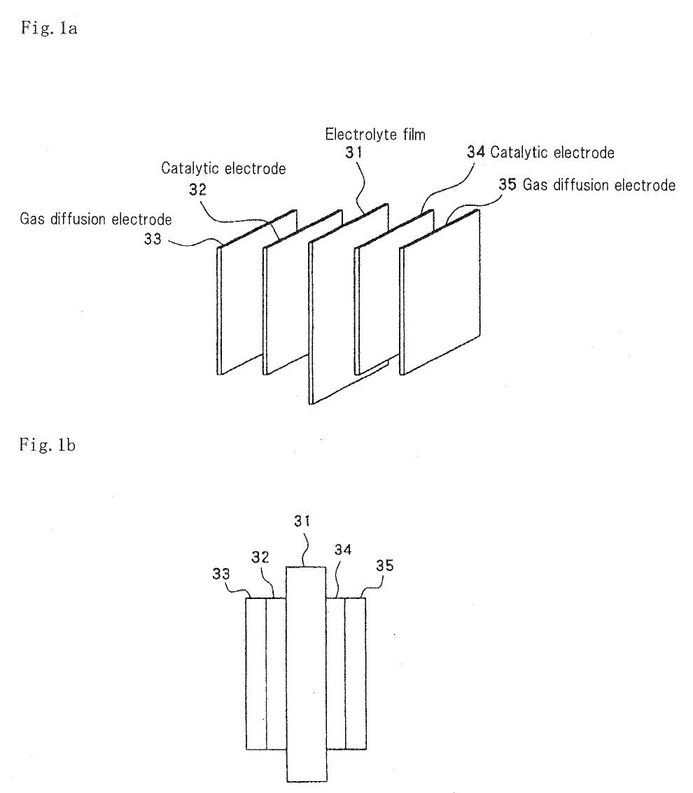

### DESCRIPTION OF SYMBOLS

100 Information processing apparatus
101 Control part
102 Display part
103 Ratio-change/disconnect switch
200 Fuel Cell unit
201 Control part
202 Storage part
203 Clock
204 Humidity sensor
205 MEA
206, 207 Valve
208, 209 Tank
300 Secondary battery unit
400 Communication line
500, 600 Power supply line
701 Hole
702 Frame electrode
703 Marker
704 Frame
705 Frame electrode
706 Fuel
707 Electrolyte film
708 Catalytic Electrode
709 Gas diffusion electrode
711 Thread hall
712 Hole

### BEST MODE FOR CARRYING OUT THE INVENTION

Next, an exemplary embodiment of the present invention will be described with reference to the drawings.

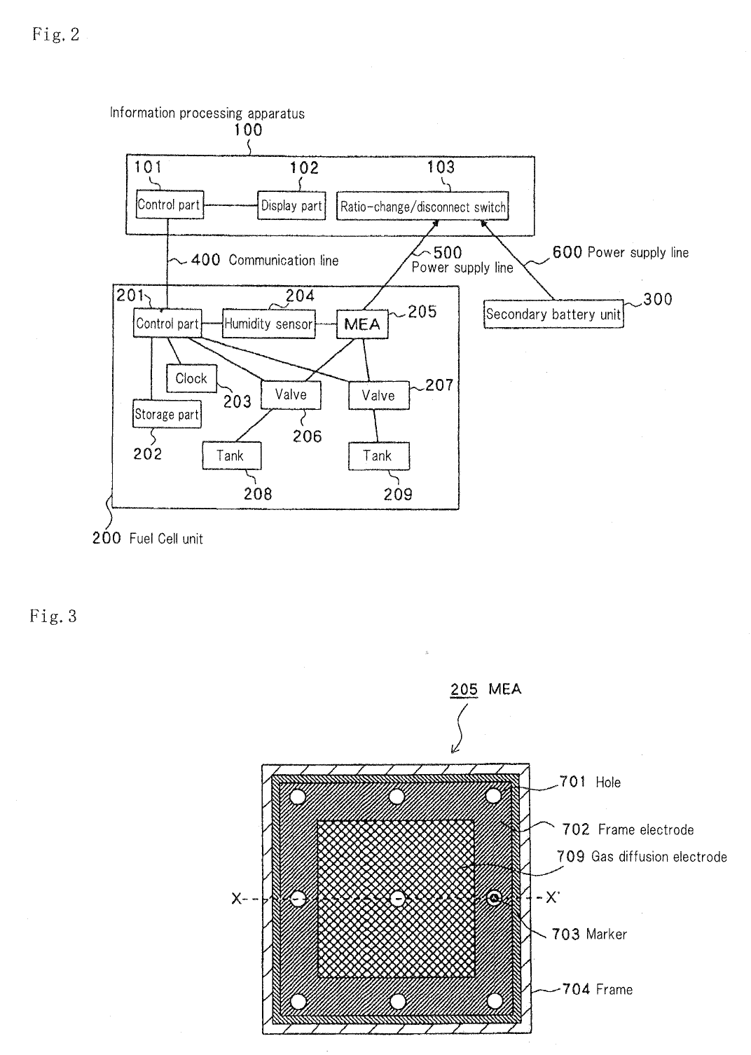

FIG. 2 is a block diagram to show the configuration of an exemplary embodiment of the present invention.

The system shown in FIG. 2 is made up of information processing apparatus 100, DMFC type fuel cell unit 200 to supply power to information processing apparatus 100, and secondary battery unit 300.

Examples of information processing apparatus 100 include portable note-type personal computers, PDAs, or mobile telephones. Since configurations to implement the functions peculiar to such electronic devices are achievable by common technologies, illustration and description thereof will be omitted.

Information processing 100 is provided with control part 101, display part 102, and ratio-change/disconnect switch 103, as the configuration relating to power supply from fuel cell unit 200 and from secondary battery unit 300.

Fuel cell unit 200 is provided with control part 201, storage part 202, clock 203, humidity sensor 204, MEA 205, valves 206 and 207, and tanks 208 and 209. Control part 101 and control part 201 are connected via communication line 400. Storage part 202, which stores programs for operating fuel cell unit 200, and which provides temporal storage for executing applications, is made up of a ROM, a RAM, a hard disk, or the like. The fuel is a liquid mixture of methanol and water, and tank 208 stores fuel having a low methanol content and tank 209 stores fuel having a high methanol content. The fuel stored in each tank 208, 209 is supplied to MEA 205 via valve 206, 207 whose open/close state is controlled by control part 201.

Fuel cell unit 200 includes, other than the above described components, a secondary battery (not shown) for initial operation, which however does not necessarily have to be included, and power may be supplied from secondary battery unit 300.

The power generated at MEA 205 is transported to ratio-change/disconnect switch 103 via power transmission line 500. Besides, power from secondary battery unit 300 is transmitted to ratio-change/disconnect switch 103 via power transmission line 600, and the ratio-change/disconnect switch 103 changes the ratio of the power reception from fuel cell unit 200 and secondary battery unit 300 or starts/disconnects the power reception from fuel cell unit 200 and secondary battery unit 300 in response to control by control part 101.

Upon detecting depression of an activation button (not shown), control part 101 of information processing apparatus 100 causes activation processing to be performed by the power from secondary battery unit 300 and detects if fuel cell unit 200 is connected. If fuel cell unit 200 is connected, an activation instruction signal for the fuel cell unit is transmitted to control part 201 of fuel cell unit 200 via communication line 400. At this moment, control part 201 of fuel cell unit 200 is operating by using the power of built-in secondary battery or secondary battery unit 300, and performs dryness testing of the MEA upon receiving an activation instruction signal.

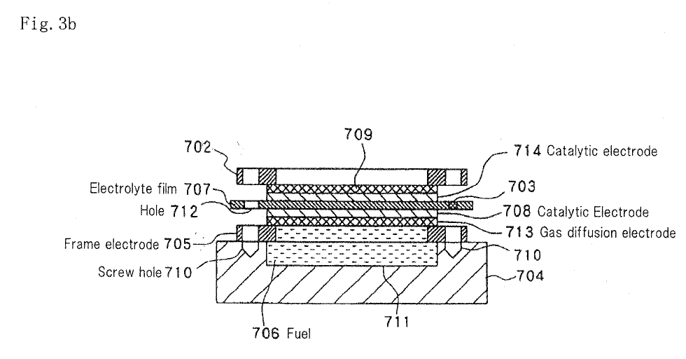

FIG. 3 shows the structure of MEA 205 of the present exemplary embodiment, where (a) indicates a top view and (b) indicates a sectional view along X-X′ line in (a).

As shown in FIG. 3(b), electrolyte film 707 is placed between catalytic electrode 708 and catalytic electrode 714, and gas diffusion electrodes 713 and 709 are provided further outside thereof. Each of gas diffusion electrodes 713 and 709 is sandwiched by frame electrodes 702 and 705 which press against the perimeter of the surface thereof on the side of electrolyte film 707. Electrolyte film 707 is provided with Marker 703, and frame electrode 702, 705 are provided with a plurality of holes 701 which are used for inserting a screw or which function as an eye hole for confirming marker 703. Electrolyte film 707 is provided with hole 712 or marker 703 at positions corresponding to holes 701. These are placed on frame 704 and unified therewith by causing a screw (not shown), which passes through hole 701 provided in frame electrode 702, to be screwed into screw hole 710 provided in frame 704. In the present exemplary embodiment, four corner edges are used for screw holes. Moreover, the configuration of MAE is not limited to the above described embodiment and, for example, a seal layer for preventing fuel from leaking to the outside through the gas diffusion electrode may be provided between the electrolyte film and the frame electrode.

Frame 704 includes liquid chamber 711 for storing fuel 706, and the fuel stored in tank 208, 209 is transported to liquid chamber 711 via valve 206, 207, which are fuel supply control means, to be supplied to catalytic electrode 708. The fuel supply control means may be a pump other than a valve, without being limited to a valve.

In the case of a MEA having the above described structure, when electrolyte film 707 dries and shrinks, hole 712 provided in electrolyte film 707 moves toward the center of electrolyte film 707, and the screw is subjected to tension in the direction toward the center of electrolyte film 707. As a result, strain occurs in frame electrode 702, 705. By detecting such phenomena, a dry state of electrolyte film 707 is detected. Specific examples of such a detection method include the following.

(1) Detecting strain generated on the top surface of frame electrode 702, 705 by using a strain gage or the like.

(2) As electrolyte film 707 moves due to drying, marker 703 moves toward the center of electrolyte film 707, thereby moving the position of marker 703, which can be viewed through hole 701 provided in frame electrode 702 corresponding to marker 703 accordingly, detecting a dry state of electrolyte film 707 by detecting the position of marker 703.

(3) Detection of the shear stress generated between the frame electrode and electrolyte film 707, catalytic electrode 708, and gas diffusion electrode 709 by providing a strain gage or the like between frame electrode 702, 705 and electrolyte film 707, catalytic electrode 708 and gas diffusion electrode 709.

From among the above described detection methods, when detection by (1) or (3) is performed, a strain sensor is used as humidity sensor 204, and when detection by (2) is performed, an image recognition apparatus, which is adapted to detect the position of marker 703 from a camera and from a picked up image of the camera, or an arrangement, which is adapted to detect the positional relationship between the hole and marker 703 by irradiating light and reading the changes in the reflected light by an optical sensor in a similar manner with a barcode reader, is used as humidity sensor 204. Control part 201 looks up the detection result of humidity sensor 204 in a table which is stored in storage part 202 and in which dryness values and the amounts of strain are correlated, or in which dryness values and the positions of the marker are correlated, to determine that a dryness value corresponding to the detection result is the dryness value for catalytic electrode 708, gas diffusion electrode 709 and electrolyte film 707 which make up MAE 205.

In the present exemplary embodiment, as described above, since the dry state of electrolyte film 707, catalytic electrode 708, and gas diffusion electrode which make up the MAE is determined, not from the amount of displacement in the laminating direction thereof, but from the amount of displacement in an in-plane direction of the film, high accuracy of detection is achieved.

Further, as a matter of course, each of the detection methods may be performed in parallel. By determining the dryness value from the quantities detected in parallel, further increasing the detection accuracy is made possible.

Hereinafter, the control that uses the dryness value obtained as described above will be described.

### Dryness Testing of MEA

Upon detecting a dryness value from the output of sensor 204, control part 201 of fuel cell unit 200 compares the detected dryness value with the dryness reference value pre-stored in storage part 202, and if the detected dryness value is higher than the dryness reference value, recognizes that it indicates a dry state.

Further, when the operation of information processing apparatus 100 is terminated, control part 201 stores the termination time and date in storage part 202. Further, upon receiving an activation instruction signal from control part 101, control part 201 calculates the activation time from the previous termination time and date to the current activation (current time and date) and compares the calculated activation time with the reference activation time pre-stored in storage part 202 to recognize that it indicates a dry state if the activation time is longer than the reference activation time.

Since there may be a case in which information processing apparatus 100 is not normally terminated and in which the termination time and date cannot be recorded, an initiation time and date may also be recorded so that, when the previous termination time and date cannot be read out, the activation time may be calculated using the previous initiation time and date. It may also be such that only the initiation time and date are used without using the termination time and date.

Information processing apparatus 100 may be configured such that the termination time and date (or initiation time and date) are stored in a storage part (not shown) of information processing apparatus 100 when control part 101 of information processing apparatus 100 transmits a termination instruction signal/activation instruction signal to control part 201 of fuel cell unit 200, and when control part 101 of information processing apparatus 100 detects a dry state through calculation using the termination time and date (or initiation time and date).

As described above, in the present exemplary embodiment, the detection of a dry state is performed by two different detection methods, i.e. detection by a humidity sensor and detection by an activation time, thereby ensuring reliable detection. However, that apparatus may also be configured to perform only one detection method for the purpose of simplifying the apparatus configuration.

Upon recognizing a dry state, control part 201 of fuel cell unit 200 notifies control part 101 of information processing apparatus 100 of a dryness signal that indicates that communication line 400, connected to information processing apparatus 100, is in a dry state. Upon receiving the dryness signal, control part 101 of information processing apparatus 100 causes display part 102 to display a dryness warning that indicates that fuel cell unit 200 is in a dry state, thereby bringing this state to the attention of the user. In this display screen, a display may be made to notify users that the following humidification of the MAE will be performed.

Upon recognizing a dry state, control part 201 of fuel cell unit 200 performs the following humidification of the MEA.

### Humidification of the MAE

Control part 201 of fuel cell unit 200 notifies control part 101 of information processing apparatus 100 of a dryness signal indicating a dry state. Upon receiving the dryness signal, control part 101 of information processing apparatus 100 performs control through ratio-change/disconnect switch 103 such that the load on the power supply from fuel cell 200 becomes zero or a minimum. The control of the load is performed by disconnecting the power that is received from fuel cell 200 or by increasing the ratio of the power supplied from secondary battery 300.

Control part 201 of fuel cell unit 200 opens valves 206 and 207 in the fuel path leading from tanks 208 and 209 to MEA 205 to supply fuel to MEA 205.

After supplying fuel, control part 201 of fuel cell unit 200 measures a dryness value of MEA 205 by the output from humidity sensor 204 and when the measured dryness value becomes lower than a reference dryness value (or a second reference dryness value lower than the reference dryness value), recognizes that fuel cell unit 200 is ready to supply power, and notifies control part 101 of information processing apparatus 100 of an output ready signal indicating as such. Upon receiving the output ready signal, control part 101 of information processing apparatus 100 gradually increases the load on the fuel cell by starting to receive power from fuel cell unit 200 or by decreasing the ratio of the power supplied from secondary battery unit 300 by means of ratio-change/disconnect switch 103.

Control part 201 of fuel cell unit 200 causes valves 206 and 207, which are in the fuel path linking from tanks 208 and 209 to MEA 205, to be opened to a lesser degree than in normal operation, and supplies fuel to MEA 205. Moreover, as described above, fuel having a low methanol content is stored in tank 208 and fuel having a high methanol content is stored in tank 209, and at this moment, the fuel with the low methanol content stored in tank 208 is supplied to MEA 205. Moreover, this processing is continued until the dryness value of MEA 205 indicated in the detection result of humidity sensor 205 becomes lower than the reference dryness value, or until any of the following three conditions required of a humidified state of MEA 205 is satisfied.

Condition 1: The amount sufficient to humidify the binder contained in the fuel electrode and the gas diffusion electrode, the amount being varied depending on the kind of the electrode.

Condition 2: The amount sufficient to humidify the binder contained in the electrolyte film, the amount being varied depending on the kind of the electrolyte film.

Condition 3: The amount needed for power generation; 0.25 A/h.

By opening valves 206 and 207 to a lesser degree than in normal operation, the interior of the MEA will be sufficiently humidified. Further, by supplying more fuel that has a low methanol content, the time needed for humidification will be decreased.

While in the exemplary embodiments so far described, description has been made about a direct methanol fuel cell, in the case of a solid polymer type in which hydrogen is supplied to the MEA, the configuration may be such that tank 208 stores water and tank 209 stores fuel such as hydrogen gas and the like. The fuel hydrogen gas in tank 209 is humidified by being passed through a humidifier unit, which utilizes water in tank 208, such as a bubbler and is fed to the catalytic electrode on the anode side.

1. A dry-state detecting method for a fuel cell comprising a power generation part, said power generation part being made up of an electrolyte film, and a catalytic electrode and a gas diffusion electrode which are disposed on each side of said electrolyte film, said dry-state detecting method for a fuel cell characterized in that
a dry state is detected based on an amount of displacement in an in-plane direction of said electrolyte film.

2. The dry-state detecting method for a fuel cell according to claim 1, characterized in that
said frame electrode and said electrolyte film are integrally joined by a screw so that a dry state is detected based on an amount of strain in a frame electrode sandwiching said power generation part.

3. The dry-state detecting method for a fuel cell according to claim 1, characterized in that
said frame electrode and said electrolyte film are integrally joined by a screw so that a dry state is detected based on a position of a maker placed on said electrolyte film.

4. The dry-state detecting method for a fuel cell according to claim 1, characterized in that
said frame electrode and said electrolyte film are integrally joined by a screw so that a dry state is detected based on an amount of strain between said frame electrode sandwiching said power generation part, and said power generation part.

5. An electronic device system comprising an information processing apparatus, and a fuel cell unit and a secondary battery unit for supplying power to said information processing apparatus, characterized in that
said information processing apparatus comprises:
a first control part; and
a ratio-change/disconnect switch for changing the ratio of and disconnecting power supply from said fuel cell unit and said secondary battery unit, and characterized in
said fuel cell unit comprising:
a power generation part;
a humidity sensor for detecting a degree of dryness of said power generation part;
a storage part; and
a second control part which determines a dryness value indicating a degree of dryness detected by said humidity sensor to compare said dryness value with a reference dryness value pre-stored in said storage part, and which judges that said power generation part is in a dry state when the degree of dryness detected by said humidity sensor indicates a lower humidity than that indicated by said reference dryness value, to notify said first control part of a dryness signal, and that
upon receiving the notification of a dryness signal, said first control part controls said ratio-change/disconnect switch such that power is supplied only from said secondary battery unit, or more power is supplied from said secondary battery unit.

6. The electronic device system according to claim 5, characterized in that
said fuel cell unit comprises
a tank for storing fuel to be supplied to said power generation part, and that
said second control part performs control to cause fuel to be supplied from said tank to said power generation part when notifying said first control part of a dryness signal.

7. The electronic device system according to claim 5, characterized in that
said fuel cell unit comprises:
first and second tanks for storing fuel to be supplied to said power generation part; and
first and second fuel supply control means provided in a supply path respectively between said first and second tanks and said power generation part, and that
when notifying said first control part of a dryness signal, said second control part controls said first and second fuel supply control means such that fuel is supplied to said power generation part only from either one tank, or more fuel is supplied to said power generation part from either one tank.

8. The electronic device system according to claim 7, characterized in that
when notifying said first control part of a dryness signal, said second control part controls said first and second fuel supply control means to supply less fuel than is supplied during a normal operation.

9. The electronic device system according to claim 5, characterized in that:
said power generation part is made up of an electrolyte film, and a catalytic electrode and a gas diffusion electrode which are provided on each side of said electrolyte film;
a frame electrode for sandwiching said power generation part is provided, and said frame electrode and said electrolyte film are integrally joined by a screw; and
said humidity sensor is adapted to detect an amount of strain in said frame electrode.

10. The electronic device system according to claim 5, characterized in that:
said power generation part is made up of an electrolyte film provided with a marker, and a catalytic electrode and a gas diffusion electrode which are provided on each side of said electrolyte film;
a frame electrode for sandwiching said power generation part is provided, and said frame electrode and said electrolyte film are integrally joined by a screw; and
said humidity sensor is adapted to detect a position of said marker.

11. The electronic device system according to claim 5, characterized in that:
said power generation part is made up of an electrolyte film, and a catalytic electrode and a gas diffusion electrode which are provided on each side of said electrolyte film;
a frame electrode for sandwiching said power generation part is provided, and said frame electrode and said electrolyte film are integrally joined by a screw; and
said humidity sensor is adapted to detect sheer stress between said frame electrode and said power generation part.

12. The electronic device system according to claim 5, characterized in that:
said power generation part is made up of an electrolyte film provided with a marker, and a catalytic electrode and a gas diffusion electrode which are provided on each side of said electrolyte film;
a frame electrode for sandwiching said power generation part is provided, and said frame electrode and said electrolyte film are integrally joined by a screw; and
said humidity sensor is adapted to detect at least one of an amount of strain in said frame electrode, a position of said marker, and sheer stress between said frame electrode and said power generation part.

13. The electronic device system according to claim 5, characterized in that:
said electronic device system comprises a clock provided in said fuel cell unit as a humidity sensor;
when said information processing apparatus is activated or deactivated, said first control part notifies said second control part as such; and
said second control part acquires a time at which a notification of activation or deactivation of said information processing apparatus is received from said first control part, by referring to said clock, to store said time in said storage part, and in the case of a notification of activation, further calculates an activation time which is a time period from a time of previous activation or previous deactivation, to compare said activation time with a reference activation time pre-stored in said storage part, wherein said second control part is adapted to make a judgment that said power generation part is in a dry state if the determined activation time is longer than said reference activation time.

14. The electronic device system according to claim 9, characterized in that
said electronic device system comprises a clock provided in said fuel cell unit as a further humidity sensor,
when said information processing apparatus is activated or deactivated, said first control part notifies said second control part as such,
said second control part acquires a time when a notification of activation or deactivation of said information processing apparatus is received from said first control part, by referring to said clock, to store said time in said storage part, and in the case of a notification of activation, further calculates an activation time which is a time period from a time of previous activation or previous deactivation, to compare said activation time with a reference activation time pre-stored in said storage part, wherein said second control part is adapted to make a judgment that said power generation part is in a dry state if the determined activation time is longer than said reference activation time.

15. A power generation part of a fuel cell, comprising an electrolyte film, and a catalytic electrode and gas diffusion electrode which are disposed on each side of said electrolyte film, characterized in that
said frame electrode and said electrolyte film are integrally joined by a screw.

16. A power control method for an electronic device system comprising: a fuel cell unit including a power generation part, a humidity sensor for detecting a degree of dryness of said power generation part, a storage part, a first and a second tank, a first and a second valves provided in each supply path between each of said first and second tanks and said power generation part, and a second control part; a secondary battery unit; and an information processing apparatus including a ratio-change/disconnect switch which receives the supply of power from a fuel cell unit and a secondary battery unit, and changes the ratio and disconnects the power supply of the first control part and said fuel cell unit and secondary battery unit, characterized in that said power control method comprises:
arranging that said secondary control part determines a dryness value indicating a degree of dryness detected by said humidity sensor to compare said dryness value with a reference dryness value pre-stored in said storage part; and makes a judgment that said power generation part is in a dry state when said degree of dryness detected by said humidity sensor indicates a lower humidity than that indicated by the reference dryness value, to notify said first control part of a dryness signal;
controlling an open/close state of said first and second valves such that power is supplied to said power generation part only from either the first or second tank, or more power is supplied from either the first or second tank; and
arranging that upon receiving the notification of a dryness signal, said first control part performs control through said ratio-change/disconnect switch such that power is supplied only from said secondary battery unit, or more power is supplied from said secondary battery unit.

17. The power control method for an electronic device system according to claim 16, characterized by further comprising:
arranging that after notifying said first control part of a dryness signal, said second control part controls the open/close state such that the opening is smaller than the opening during normal operation.

18. The power control method for an electronic device system, according to claim 16 or 17, characterized by further comprising:
a clock provided in said fuel cell unit;
arranging that when said information processing apparatus is activated or deactivated, said first control part notifies said second control part as such; and
arranging that the second control part acquires a time at which a notification of activation or deactivation of the information processing apparatus is received from the first control part by referring to the clock, to store the time in the storage part, and in the case of a notification of activation, further calculates an activation time which is a time period from a time of previous activation or previous deactivation to compare the activation time with a reference activation time pre-stored in the storage part, wherein the second control part adapted to make a judgment that the power generation part is in a dry state if the determined activation time is longer than the reference activation time.

19. The electronic device system according to claim 6, characterized in that:
said power generation part is made up of an electrolyte film, and a catalytic electrode and a gas diffusion electrode which are provided on each side of said electrolyte film;
a frame electrode for sandwiching said power generation part is provided, and said frame electrode and said electrolyte film are integrally joined by a screw; and
said humidity sensor is adapted to detect an amount of strain in said frame electrode.

20. The electronic device system according to claim 7, characterized in that:
said power generation part is made up of an electrolyte film, and a catalytic electrode and a gas diffusion electrode which are provided on each side of said electrolyte film;
a frame electrode for sandwiching said power generation part is provided, and said frame electrode and said electrolyte film are integrally joined by a screw; and
said humidity sensor is adapted to detect an amount of strain in said frame electrode.
